(19) United States
(12) Patent Application Publication
(10) Pub. No.: US 2002/0080339 A1
(43) Pub. Date: Jun. 27, 2002

(54) Stage apparatus, vibration control method and exposure apparatus

(75) Inventor: Masato Takahashi, Kumagaya-shi (JP)

Correspondence Address: OLIFF & BERRIDGE, PLC, P.O. BOX 19928, ALEXANDRIA, VA, 22320, US

(73) Assignee: Nikon Corporation, Tokyo (JP)

(21) Appl. No.: 10/023,653

(22) Filed: Dec. 21, 2001

(30) Foreign Application Priority Data
Dec. 25, 2000 (JP) 2000-393837
Dec. 25, 2000 (JP) 2000-393838

(51) Int. Cl. G03B 27/58

(52) U.S. Cl. 355/72; 355/75; 355/76; 355/73; 355/53; 310/10; 310/12; 378/34

(57) ABSTRACT

A vibration control method of a stage apparatus having a main stage body that is driven over a base plate, which controls vibration by providing a force to the base plate. The position of a center of gravity and a position of a major inertia axis of the stage apparatus is detected when vibration is applied to the base plate, and the force is controlled based on the detected position of the center of gravity and the major inertia axis. As a result, in this vibration control method, force is controlled based on the actual position of the center of gravity and the major inertia axis, which is determined when vibration is applied to the base plate of actual equipment or by simulation rather than based on the position of the center of gravity and the major inertia axis in a design model. Hence, residual vibration of the base plate is effectively controlled.

### INCORPORATION BY REFERENCE

The disclosures of Japanese Priority Application No. 2000-393837 filed Dec. 25, 2000, and of Japanese Priority Application No. 2000-393838 filed Dec. 25, 2000, are incorporated herein by reference in their entireties.

### BACKGROUND OF THE INVENTION

1. Field of Invention

The invention relates to vibration control methods for controlling vibration in stage apparatus, and to such stage apparatus and exposure apparatus that include the stage apparatus to perform an exposure process using a mask and a substrate which are held by the stage apparatus, and to such exposure apparatus that are used in lithography processes to manufacture devices such as semiconductor integrated circuits and liquid crystal displays.

2. Description of Related Art

Various exposure apparatus have been used in lithography processes, and semiconductor production processes, to transfer circuit patterns formed on a mask or a reticle (hereafter referred to as reticle) onto such substrates as a resist (photosensitive agent) -coated semiconductor wafer or glass plate (collectively referred to as substrates).

One type of exposure apparatus is a reduction projection exposure apparatus (stepper) which reduces and transfers reticle patterns onto a substrate using a projection optical system is used as a semiconductor device exposure apparatus.

A step-and-repeat type stationary exposure reduction projection exposure apparatus (stepper) which sequentially transfers a reticle pattern onto a plurality of shot regions (exposure regions) on a substrate and a step-and-scan type scanning exposure apparatus (scanning stepper) which transfers a reticle pattern onto each shot region on a substrate by synchronously moving a reticle and a substrate primarily in one direction, as disclosed in Japanese Laid Open Patent Publication No. 8-166043 are examples of such a reduction projection exposure apparatus.

These reduction projection exposure apparatus can include a base plate that is installed on a floor surface as part of the stage apparatus, and which becomes a reference surface. A main column is mounted on the base plate for supporting a reticle stage, a wafer stage, a projection optical system (projection lens) and the like through an anti-vibration mount for shielding floor vibration from all mounted components. As the anti-vibration mount, it is known to use an active anti-vibration mount (or mechanism) which includes an actuator such as an air mount and a voice coil motor with controllable internal pressure and which controls the vibration of the main column by controlling the thrust (force) supplied by the voice coil motor and the like based on the measurement values of six acceleration meters (accelerometers), for example, which are installed on the main column (main frame).

The aforementioned stepper and scanning stepper sequentially expose each of a plurality of shot regions on a substrate. Hence, there may be created relative positional errors between the projection optical system and the substrate because the reaction force generated by the acceleration and deceleration of the wafer stage (in the case of a stepper), or by the reticle stage and the wafer stage (in the case of a scanning stepper) causes vibration of the main column, which in turn causes transfer of the reticle pattern to a position differing from the design value on the substrate, or causes a blurred image (decreased image resolution) when the position error contains a vibration component.

In the aforementioned active vibration prevention mount, the problems described above are controlled by applying a force to some portion of the stage (e.g., the main column) to offset vibrations caused by the reaction forces generated during acceleration and deceleration. The force is determined based upon motion characteristics of the body (the stage) by using parameters of the apparatus which are computed beforehand, such as the center of gravity of the body, the major inertia axis, servo gain, damping characteristics of the mount, and the like. The apparatus disclosed in U.S. Pat. No. 5,528,118, for example, in which the reaction force produced by the movement of a wafer stage is mechanically removed through the floor (the ground) using a frame member (a reaction frame) provided to vibrate independently of the base plate, or the apparatus disclosed in U.S. Pat. No. 5,874,820, for example, in which the reaction force produced by the movement of reticle stage (and, optionally, the wafer stage) is mechanically removed through the floor (the ground) using a reaction frame provided to vibrate independently of the base plate also are used to address the aforementioned problems

It also is known to provide a structure in which a projection optical system and a stage apparatus for moving substrates are mounted to independent support frames, each having its own active anti-vibration mechanism to prevent the transmission of vibration between each unit.

Moreover, in a conventional system, an illumination optical system for illuminating a reticle is supported by a frame member, but in recent years, in order to eliminate vibration caused by driving of elements of the illumination optical system, the illumination optical system has been divided into two sections. For example, one section which is supported by the frame member holds stationary components of the system, while the other section, which vibrates independently of the frame member, includes a reticle blind which is driven to set the illumination region for the reticle. In this manner, the adverse effect on exposure accuracy of vibration caused during setting the illumination region is avoided.

However, a number of problems exist in the aforementioned apparatus. Because the illumination optical system is divided, when the reticle stage or the wafer stage moves, the frame member may move relative to the portion of the illumination optical system which is arranged to vibrate independently. Conversely, the portion of the illumination optical system which is arranged to vibrate independently may move relative to the frame member due to driving of the blind. If the blind and the frame member move relative to each other in this manner during exposure, the relative positional relationship between the reticle supported by the frame member and the blind changes, which in turn changes the illumination region of the reticle, resulting in a deterioration of position accuracy and overlaying accuracy of the pattern to be exposed and formed on the substrate.

Meanwhile, an optical system for converting illumination light which illuminates the reticle, for example, to parallel light beams is sometimes arranged between the reticle and the projection optical system. However, recently the position shift of the patterns exposed and formed on the substrate have been thought to be caused partly by position error, such as tilting of the optical system. For this reason, the development of an exposure apparatus which takes such a position error of the optical system into consideration is desired.

The demand for even finer semiconductor devices and higher speed exposure process is constantly present, and the development of a stage apparatus and exposure apparatus capable of meeting such demand is an urgent task.

However, even if the vibration of a stage apparatus is controlled using parameters that are computed beforehand by computers and the like, some residual vibration of the body always remains due to slight differences between the actual equipment and the calculated value. This limits an improvement in exposure accuracy.

Furthermore, in order to control the relative position errors between the projection optical system and the substrate, for example, a so-called velocity control method in which the stage velocity is feedback-controlled has been adopted recently, because this method has superior controllability compared to a so-called position control method in which the stage position measured by a laser interferometer and the like is feedback-controlled. In this case, however, follow-up control cannot be executed sufficiently well if the projection optical system vibrates, even if vibration of the stage apparatus alone is controlled with high accuracy, resulting in failure to maintain the relative position of the projection optical system, and the substrate and the like.

In order to improve exposure accuracy, it has been considered to sufficiently reduce the vibration of the main body column by using the aforementioned active anti-vibration stage before starting exposure. For example, the alignment operation and the exposure operation are not started until after the wafer stage (and the reticle stage for a scanning stepper) is/are positioned and sufficiently settled in the desired position. However such a method is not practical due to the worsening of throughput (productivity). In fact, when the wafer stage, which moves on the base plate corresponding to the position of the shot region, moves toward an edge of the base plate, vibration increases, resulting in the problem of requiring a longer time for settling.

Meanwhile, when the movable portion of the motor provided in the stage moves relative to the stationary portion of the motor, a reaction force associated with the movement is applied to the stationary portion, and in order to remove the reaction force mechanically through the floor using a reaction frame, a voice coil motor (a “trim” motor) and the like may be installed between the stationary portion and the reaction frame to transmit the reaction force to the reaction frame while controlling the position of the stationary portion. However, the reaction force may be as strong as 1,000N, which requires a large voice coil motor, resulting in the problems of a larger apparatus and higher cost.

### SUMMARY OF THE INVENTION

In view of the aforementioned problems, the invention aims to provide a stage apparatus, an anti-vibration method and an exposure apparatus which contribute to improvement in exposure accuracy. Another object of the invention is to provide a stage apparatus and an exposure apparatus that contributes to improvement in throughput. Another object of the invention is to provide a stage apparatus and an exposure apparatus that contribute to the miniaturization of the apparatus. Furthermore, the invention aims to provide an exposure apparatus which contributes to an improvement in exposure accuracy, such as position accuracy and overlaying accuracy of the patterns.

In order to achieve the above and/or other objects, one aspect of the invention relates to a vibration control method of the stage apparatus having a main stage body that is driven over a base plate, and which controls vibration by providing a force to the base plate, wherein the position of a center of gravity and position of a major inertia axis of the stage apparatus is detected when vibration is applied to the base plate, and the force is controlled based on the detected position of the center of gravity and the major inertia axis.

As a result, in the vibration control method according to this aspect of the invention, force is controlled based on the actual position of the center of gravity and the major inertia axis, which is determined when vibration is applied to the base plate of actual equipment or by simulation rather than based on the position of the center of gravity and the major inertia axis in a design model. Hence, residual vibration of the base plate is effectively controlled.

A stage apparatus according to another aspect of the invention includes a main stage body that is driven over a base plate, and a force actuator that applies a force to the base plate. Such apparatus also includes a detector that detects a position of a center of gravity and a position of a major inertia axis of the stage apparatus when vibration is applied to the base plate, and a controller that controls the force that is applied to the base plate by the force actuator based on the detection results of the detector.

As a result, in the stage apparatus of this aspect of the invention, force is controlled based on the actual position of the center of gravity and the major inertia axis when vibration is applied to the base plate of actual equipment or by simulation rather than based on the position of the center of gravity and the major inertia axis in a design model. Hence, residual vibration of base plate is effectively controlled.

Another aspect of the invention relates to a stage apparatus having a main stage body that is driven over a base plate and comprises a driver having a stationary portion and a movable portion, for driving the main stage body, a support that is arranged so that it vibrates independently from the base plate, and a reaction force transmission apparatus, provided between the support and the stationary portion, for transmitting the reaction force generated in the stationary portion by the movement of the main stage body to the support. According to this aspect, the reaction force transmission apparatus comprises an EI core actuator made by connecting an E-type core and an I-type core.

Hence, because an EI core actuator is able to output 1.5 times as much force as a voice coil motor, installation of an EI core actuator ⅔ the size of voice coil motor results in the output of the same amount of force to be transmitted to the support, enabling miniaturization of the apparatus.

Another aspect of the invention relates to a stage apparatus having a main stage body that is driven over a base plate, and a force actuator that applies a force to the base plate, and comprises a memory that stores vibration characteristics of the base plate corresponding to different positions of the main stage body, a vibration detector that detects vibration characteristics of the base plate, a controller that controls driving of the force actuator based on the detection results of the vibration detector and the storage contents of the memory.

As a result, in the stage apparatus of this aspect of the invention, the vibration characteristics of residual vibration and the like generated corresponding to the position of the main stage body is known beforehand. Hence, it becomes possible to determine the characteristics of the vibration generated in the base plate based on the vibration characteristics detected by the vibration detector. Hence, the residual vibration in the base plate may be reduced by feed forward control, resulting in shortening the time required for settling.

Another aspect of the invention relates to an exposure apparatus that exposes a pattern of a mask held by a mask stage onto a substrate held by a substrate stage, wherein at least one of the mask stage and the substrate stage is the stage apparatus discussed above.

As a result, in such an exposure apparatus, residual vibration generated when the mask or the substrate is moved is effectively controlled, and the mask or the substrate is able to be moved by a small stage apparatus. Moreover, throughput is improved because the settling time is shortened while positioning the stage.

Another aspect of the invention relates to an exposure apparatus that transfers a pattern of a mask onto a substrate using a projection optical system, and comprises a detector that detects a relative velocity between the projection optical system and the substrate in the optical axis direction of the projection optical system, and a drive controller that causes at least the substrate to follow the projection optical system in the optical axis direction based on detection results of the detector.

As a result, in the exposure apparatus of this aspect of the invention, even when the projection optical system vibrates, for example, the substrate may be made to follow the projection optical system while controlling the velocity using the relative velocity detected between the projection optical system and the substrate. Hence, the relative position of the projection optical system and the substrate is maintained, resulting in an improvement in the accuracy of the transcribing patterns. In this case, not only the substrate, but also the projection optical system may be driven.

Another aspect of the invention relates to an exposure apparatus in which a pattern of a mask that is illuminated by an illumination optical system is transferred onto a substrate, and comprises a support that supports at least one section of the illumination optical system and the mask (R), an illumination region defining unit that sets an illumination region of the mask and is being arranged in such a manner that it vibrates independently of the support, a detector that detects a relative positional relationship between that at least one section of the illumination optical system and the illumination region defining unit, and a controller that causes adjustment of the position of the illumination region defining unit based on the detection results of the detector.

Hence, in the exposure apparatus of this aspect of the invention, the detector detects the relative positional relationship between the illumination optical system supported by the support and the illumination region defining unit when the support and the illumination region defining unit move relative to each other, and the position of the illumination region defining unit is adjusted based on the detected relative positional relationship. Hence, the illumination region for the mask is maintained constant without change, resulting in prevention beforehand of deterioration of position accuracy and overlaying accuracy of the pattern to be exposed and formed on the substrate.

Another aspect of the invention relates to an exposure apparatus that transfers a pattern of a mask onto a substrate through a projection optical system located between the mask and the substrate, comprising: an optical member arranged between the mask and the projection optical system; a measurement instrument that measures a relative positional relationship between the optical member and the projection optical system; and a controller that controls adjustment of a position of the image of the pattern of the mask that is projected onto the substrate based on the relative positional relationship measured by the measurement instrument.

Hence, in the exposure apparatus of this aspect of the invention, even if a position error of the optical member is present, the measurement instrument measures the relative positional relationship, including the position error, and the pattern image to be projected onto the substrate is adjusted based on the relative positional relationship. Hence the deterioration of position accuracy and overlying accuracy of the patterns may be prevented beforehand.

### BRIEF DESCRIPTION OF THE DRAWINGS

The invention will be described in detail with reference to the following drawings, in which like reference numerals are used to identify similar elements, and wherein:

FIG. 1 is a schematic diagram of an exposure apparatus according to one exemplary embodiment of the invention;

FIG. 2 is a schematic diagram of the exposure apparatus in which a second illumination optical system is supported by the reaction frame;

FIG. 3 is a plan view of a movable reticle blind that is part of the illumination optical system;

FIG. 4 is an external oblique view of a reticle stage that is part of the exposure apparatus;

FIG. 5 is an external oblique view of a wafer stage that is part of the exposure apparatus;

FIG. 6 is a block diagram illustrating a control system of the exposure apparatus;

FIGS. 7A-7C are respective output graphs of accelerometers of the wafer base plate;

FIG. 8 is a schematic diagram illustrating the position of the center of gravity and the major inertia axis in an exposure apparatus;

FIG. 9 is a block diagram showing a control loop of the vibration control using a map;

FIG. 10 is block a diagram showing a control loop for driving a wafer to follow a projection optical system under controlled velocity;

FIG. 11 is a block diagram showing a control loop for driving a wafer to follow a projection optical system under controlled velocity;

FIG. 12 is a flow chart representing an example of a semiconductor device production process; and

FIGS. 13A and 13B are assembled and exploded views, respectively, of an EI core actuator that can be used as a reaction force transmission apparatus according to a modified embodiment of the invention.

### DETAILED DESCRIPTION OF PREFERRED EMBODIMENTS

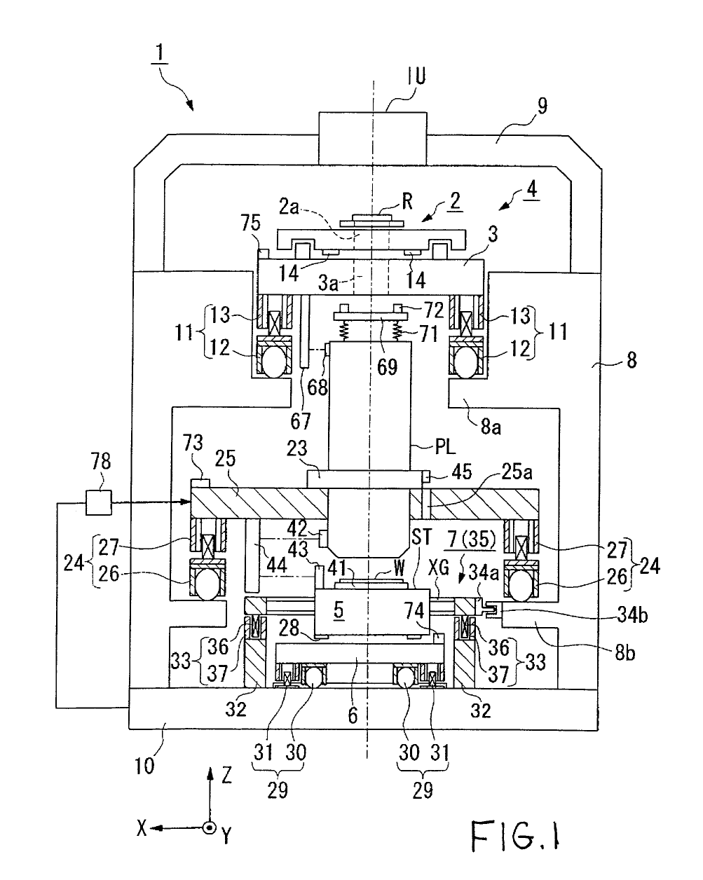

The configuration of an exposure apparatus according to an exemplary embodiment of the invention is described hereafter, with reference to FIG. 1 through FIG. 12 . Here, an explanation is presented by using an example in which a scanning stepper is used as an exposure apparatus in which the circuit patterns of a semiconductor device formed on a reticle are transferred onto a substrate while synchronously moving the reticle and the substrate. In this exemplary exposure apparatus, the stage apparatus of the invention is applied to the wafer stage. However, the stage apparatus of the invention may be applied to either or both of the reticle and wafer stages.

The exposure apparatus 1 shown in FIG. 1 includes an illumination optical system IU for illuminating a rectangular-shape (or slit-shape) illumination region on the reticle (mask) R with uniform illuminance of exposure illumination light from a light source LS (see FIG. 2) , a stage apparatus 4 including a reticle stage (mask stage) 2 which moves while holding reticle R and a reticle base plate 3 which supports the reticle stage 2, a projection optical system PL which projects illumination transmitted through the reticle R onto the wafer (substrate) W, a stage apparatus 7 containing a wafer stage (substrate stage, stage body) 5 which moves while holding the wafer and a wafer base plate (base plate) 6 which holds the wafer stage 5, and a reaction frame 8 which supports the stage apparatus 4 and the projection optical system PL. In this instance, the direction of the optical axis of the projection optical system PL is defined as the Z direction, the direction perpendicular to the Z direction and the direction of synchronous movement of the reticle R and the wafer W is defined as the Y direction, and the asynchronous movement direction is defined as the X direction. The rotational direction around each axis is respectively defined as θZ, θY, and θX.

An ArF excimer laser light source that outputs pulsed ultraviolet light, whose band is narrowed to avoid an oxygen absorption band, having a wavelength of 192-194 nm is used here as a light source LS. The main body of the light source LS is installed on the floor FD of a clean room in a semiconductor manufacturing plant. A light source control apparatus, not shown, is provided for the light source LS, which light source control apparatus executes control of the oscillation central wavelength and spectral half value width of the pulsed ultraviolet light being emitted, trigger control of the pulse oscillation, and control of gas in the laser chamber. In this instance, a KrF excimer laser light source which emits pulsed ultraviolet light of 248 nm wavelength or an F2 laser light source which emits ultraviolet light of 157 nm wavelength may be used as a light source. The light source LS may be installed in a separate room (service room) having a lower degree of cleanliness than the clean room or in an utility space provided under the clean room floor.

FIG. 2 illustrates that the light source LS is connected to one end (incident end) of a beam matching unit BMU through a light shielding bellows or conduit (not represented in FIG. 2 for the sake of convenience in the drawing). The other end of the beam matching unit BMU is connected to a first illumination optical system IU1 of the illumination optical system IU through a pipe 61 containing an internal relay optical system. The relay optical system and a plurality of movable reflection mirrors (both of which are unrepresented) are installed in the beam matching unit BMU. The movable reflection mirrors are used to match the position of the optical path of the pulsed ultraviolet light (ArF excimer laser light) which is incident from the light source LS with the first illumination optical system IU1.

The illumination optical system IU includes the first illumination optical system IU1 and a second illumination optical system IU2. The first illumination optical system IU1 is installed on a support plate 10 called a frame caster which becomes the reference for the apparatus, and which is horizontally installed on the floor FD. The second illumination optical system IU2 is supported from below by a support column 9 which is attached to the top surface of the reaction frame (support part) 8. Hence, the first illumination optical system IU1 and the reaction frame 8 (including the second illumination optical system IU2) are allowed to vibrate independent of each other.

The first illumination optical system IU1 comprises mirrors which are arranged in a predetermined positional relationship, variable light dimming equipment, a beam forming optical system, an optical integrator, a light condensing optical system, a vibration mirror, an illumination system aperture stop plate, a beam splitter, a relay lens system, a movable reticle blind 62 (illumination region setting apparatus) as a movable field stop constituting a reticle blind mechanism, and the like. When the pulsed ultraviolet light from the LS is incident horizontally within the first illumination optical system IU1 through the BMU and relay optical system, the pulsed ultraviolet light is adjusted to a predetermined peak intensity by an ND filter of the variable light dimming equipment, after which the cross-sectional shape of the pulsed ultraviolet light is improved by the beam shaping optical system so that the light is effectively incident to the optical integrator.

When the pulsed ultraviolet light is incident to the optical integrator, the surface light source, namely a secondary light source comprising many light source images (point light sources) is formed on the exit side of the optical integrator. The pulsed ultraviolet light dispersing from each of the plurality of point light sources (secondary light source) reaches the movable reticle blind 62 to be used as exposure light after passing through one of the aperture stops.

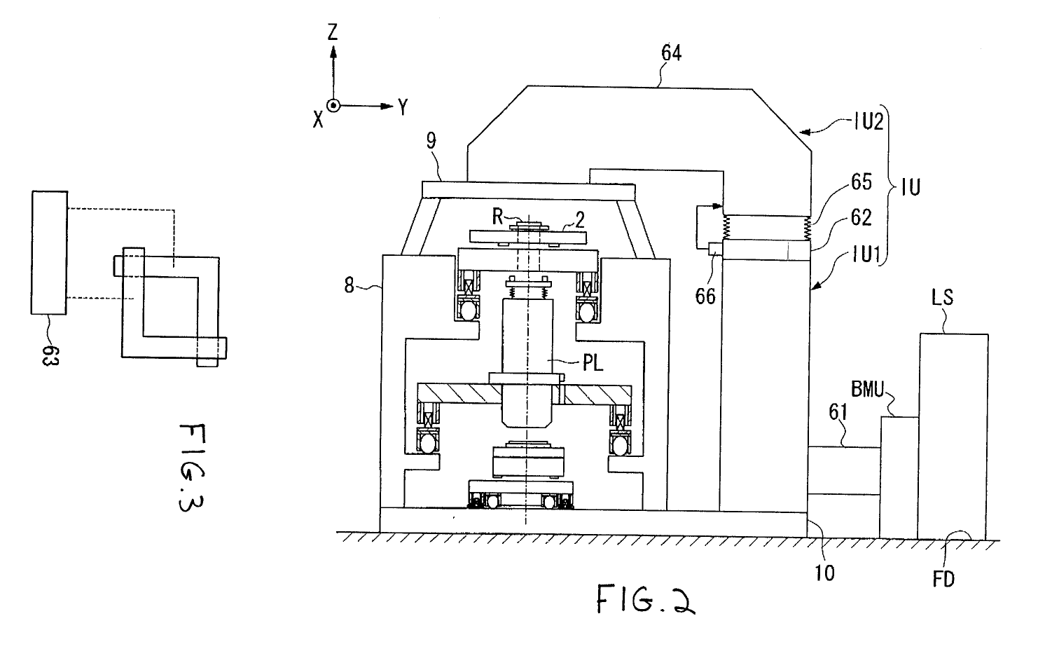

FIG. 3 shows that the movable reticle blind 62 comprises two L-shaped movable blades, and a driver 63 that drives the movable blades. The two L-shaped movable blades are able to change positions in the direction corresponding to the scanning direction of the reticle R and corresponding to the non-scanning direction perpendicular to the scanning direction. The movable reticle blind 62 is used to further restrict the illumination region on the reticle R which is defined by a fixed reticle blind, to be explained later, by movable blades during the starting and ending of scanning exposure in order to prevent the exposure of any unnecessary sections of the reticle and the substrate. Driving of the movable reticle blind 62 is controlled by a main controller 70 to be described later as an adjustment apparatus (see FIG. 6).

The second illumination optical system IU2 comprises an illumination system housing 64, a fixed reticle blind which is housed inside the illumination system housing 64 with a predetermined positional relationship, lenses, mirrors, a relay lens system, a main condenser lens and the like (not shown). The fixed reticle blind is arranged on a surface which is slightly offset from the conjugate surface relative to the pattern surface on the reticle R near the incident end of the illumination system housing 64, and an aperture with a predetermined shape which defines the illumination region on the reticle R is formed. The aperture of the fixed reticle blind is formed in a slit-shape or rectangular shape extending linearly in the X-axis direction perpendicular to the direction of movement (the Y-axis direction) of the reticle R during scanning exposure at the center of the circular field of the projection optical system PL.

The pulsed ultraviolet light passing through the aperture in the blade of the movable reticle blind 62 illuminates the aperture of the fixed reticle blind with uniform intensity distribution. The pulsed ultraviolet light, after passing through the aperture of the fixed reticle blind, passes through the lens, a mirror, the relay lens system and the main condenser system and illuminates predetermined illumination region (the slit-shaped or rectangular illumination region extending linearly in the X-axis direction) on the reticle R supported on the reticle stage 2 with uniform illuminance distribution. Here, the rectangular slit-shaped illumination light to be irradiated on the reticle R is set to extend thinly in the X-axis direction (non-scanning direction) at the center of the circular projection field of the projection optical system PL in FIG. 2 with the Y-axis direction (scanning direction) width of the illumination light being set to be substantially constant.

Tightly connecting the first illumination optical system IU1 and the second illumination optical system IU2 is not preferable because vibration generated in the first illumination optical system IU1 during exposure by driving the movable reticle blind 62 is transmitted directly to the second illumination optical system IU2 supported by the reaction frame 8. For this reason, in the present embodiment, the first illumination optical system IU1 and the second illumination optical system IU2 are connected by means of a serpentine shaped member 65, which is a connection member that freely expands and contracts, enabling a change in the relative position of the first illumination optical system IU1 and the second illumination optical system IU2, and enabling the inside to be airtight against the outside atmosphere.

A position sensor 66 such as a photo-electric sensor provided on the first illumination optical system IU1 and is arranged in the vicinity of the second illumination optical system IU2, or near the movable reticle blind 62. The position sensor 66 detects the relative distance (relative positional relationship) between the movable reticle blind 62 and one end of the second illumination optical system IU2 closest to the first illumination optical system IU1 (fixed reticle blind, for example) in the two dimensional plane defined by the X-axis and the Y-axis, and the detection results are output to the main controller 70 (see FIG. 6).

Returning to FIG. 1, a reaction frame 8 is installed on the support plate 10, and step sections 8a and 8b are formed respectively on an upper section and a lower section of the reaction frame 8.

In the stage apparatus 4, the reticle base plate 3 is supported substantially horizontally by the step section 8a of the reaction frame 8 at each corner of the base plate 3 by four anti-vibration units 11 (only two are shown in FIG. 1). An aperture 3a through which the image of the pattern formed on the reticle R passes through is provided in the center of the reticle base plate 3. A material such as metal and/or ceramic may be used for the reticle base plate 3. Each anti-vibration unit 11 includes an air mount 12 with an adjustable inner pressure and a voice coil motor 13 which provides thrust (a force) to the reticle base plate 3 arranged in series on the step section 8a. By means of the anti-vibration units 11, small vibrations transmitted to the reticle base plate 3 through the support plate 10 and the reaction frame 8 are insulated at the micro G level (G is gravitational acceleration).

Reticle stage 2 is supported on the reticle base plate 3 in such a manner that the reticle stage 2 is able to move in a two-dimensional plane along the reticle base plate 3. A plurality of air bearings (air pads) 14 are provided on the bottom surface of the reticle stage 2 as noncontact bearings. Through air bearings 14, reticle stage 2 is float supported above the reticle base plate 3 with a clearance of several microns. An aperture 2a where the image of the pattern of the reticle R passes through is formed coaxially with the aperture 3a of the reticle base plate 3 in the center of the reticle stage 2.

A plurality (three for example, only one is shown in FIG. 1) of accelerometers 75 are provided on the reticle base plate 3. The measurement results of the accelerometers 75 are output to the main controller 70, to be explained later (see FIG. 6).

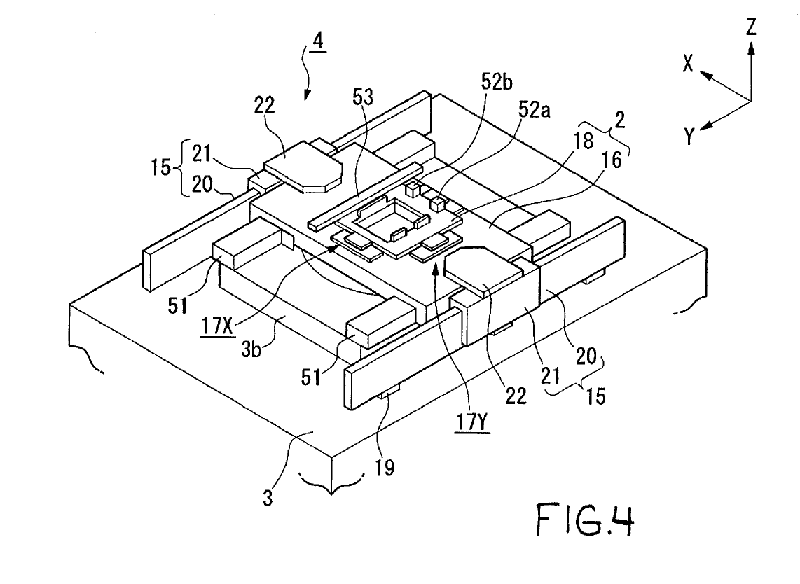

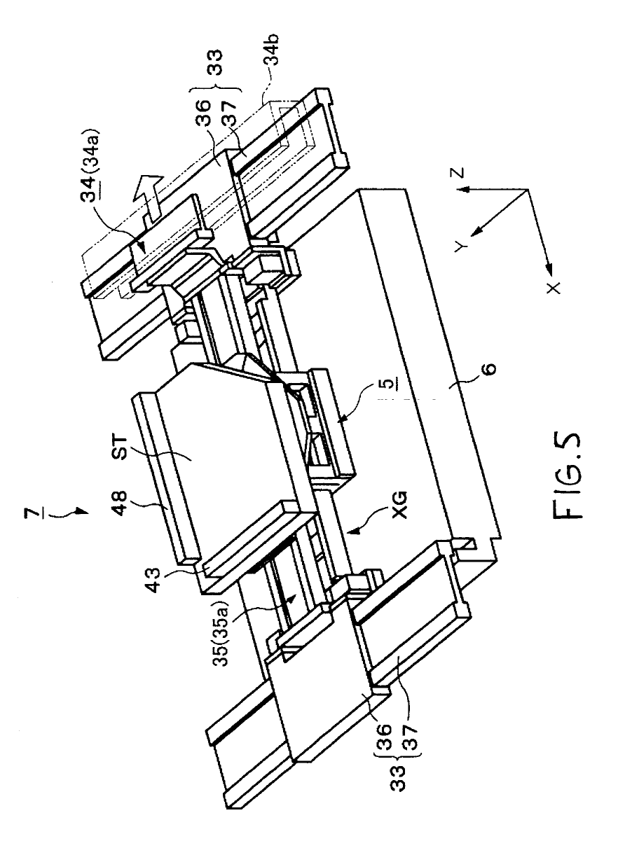

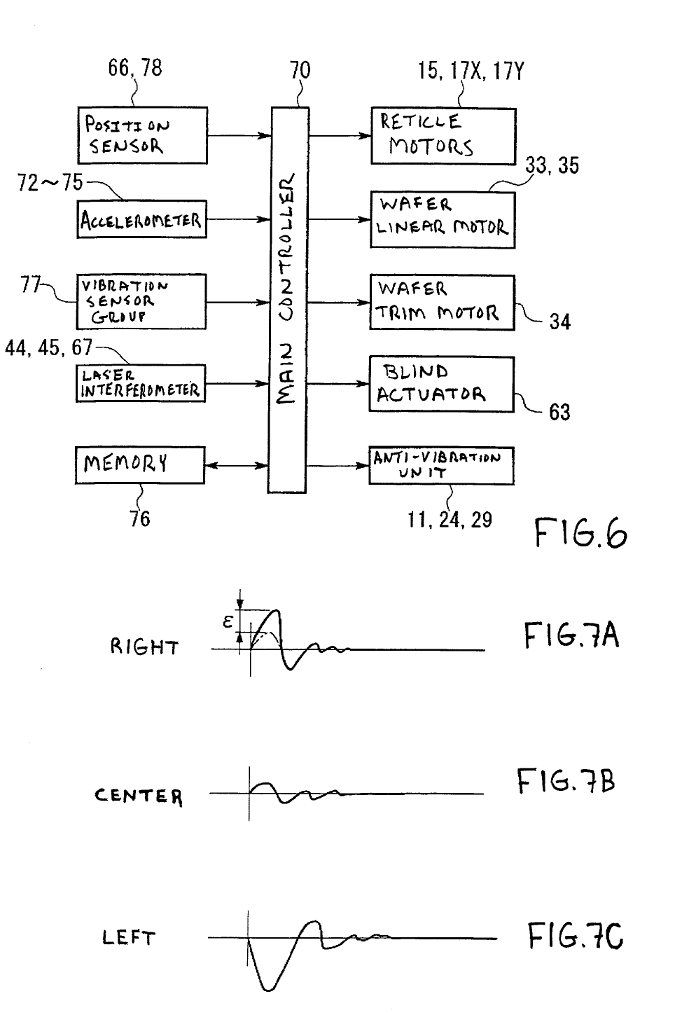

Next, reticle stage 2 will be described in detail. FIG. 4 shows that the reticle stage 2 includes a reticle coarse movement stage 16, which is driven in the Y-axis direction by a pair of Y linear motors 15, 15 with a predetermined stroke over the reticle base plate 3, and a reticle fine movement stage 18 which is driven slightly in the X, Y, θZ directions by a pair of X voice coil motors 17X and a pair of Y voice coil motors 17Y on the reticle coarse movement stage 16 (these are represented as one stage in FIG. 1).

Each Y linear motor 15 includes a stationary portion 20 which is float supported by a plurality of non-contact air bearings 19 and extends in the Y-axis direction on the reticle base plate 3, and movable portions 21 installed corresponding to the stationary portions 20 and is attached to the reticle coarse movement stage 16 through a connection member 22. Hence, due to the law of conservation of momentum, the stationary portion 20 moves in the -Y direction in response to movement in the +Y direction of the reticle coarse movement stage 16. The movement of the stationary portion 20 offsets the reaction force associated with the movement of the reticle coarse movement stage 16, and any change in the position of the center of gravity is prevented.

The stationary portion 20 may be installed on the reaction frame 8 instead of the reticle base plate 3. If the stationary portion 20 is provided on the reaction frame 8, bearings 19 may be omitted and the stationary portion 20 will be anchored on the reaction frame 8 to remove the reaction force applied to the stationary portion 20 by the movement of the reticle coarse movement stage 16 by means of the reaction frame 8 through the floor.

Reticle coarse movement stage 16 is guided in the Y-axis direction by a pair of Y guides 51, 51 which are attached and extend in the Y-axis direction on the top surface of an upper protrusion 3b formed in the central section of the reticle base plate 3. The reticle coarse movement stage 16 is non-contact supported with respect to the Y guides 51, 51 by unrepresented air bearings.

Reticle R is suction held to the reticle fine movement stage 18 by means of an unrepresented vacuum chuck. A pair of Y movable mirrors 52a and 52b made of corner cubes are attached to the −Y direction end of the reticle fine movement stage 18, and an X movable mirror 53 made of a flat mirror extending in the Y-axis direction is attached to the +X direction end of the reticle fine movement stage 18. Three laser interferometers (only laser interferometer 67 is shown in FIG. 1) irradiate measurement laser beams onto the movable mirrors 52a, 52b and 53 respectively and onto reference mirror 68 which is attached near the top end of the lens barrel of the projection optical system PL. By measuring the relative displacement of the movable mirrors and the reference mirror based on the interference between the reflected light and incident light, X, Y, θZ (rotation around the Z-axis) position of reticle stage 2 (and ultimately reticle R) is measured in real time with a predetermined resolution, about 0.5˜1 nm resolution, for example. Here, highly rigid and low thermal expansion material such as certain metals, cordierite, and ceramic made of SiC are preferably used for the reticle fine movement stage 18.

In FIG. 1, a refractive optical system with a reduction ratio of ¼ (or ⅕) comprising refractive optical elements (lens elements) made of optical glass material such as silica or fluorite with both object surface (reticle R) side and image surface (wafer W) side being telecentric and having a circular projection field is used as the projection optical system PL. Hence, when illumination light is irradiated onto the reticle R, imaging light beams from the section of the reticle being illuminated by the illumination light in the circuit pattern on reticle R is incident to the projection optical system PL through the optical member 69 (explained later), and a partial image of the circuit pattern, having a slit-shape, is imaged in the center of the circular field at the image surface side of projection optical system PL. As a result, the partial image of the projected circuit pattern is reduction-transferred onto a resist layer of one shot region out of a plurality of shot regions on the wafer W arranged on the imaging surface of the projection optical system PL.

Optical member 69, which receives exposure light that has illuminated and passed through the reticle R as a telecentric parallel light beam into the projection optical system PL is provided between the projection optical system PL and the reticle R. The optical member 69 (for example, a glass plate) is supported by the lens barrel of the projection optical system PL through an elastic member 71 with a small spring constant such as a plate spring or coil spring. Three accelerometers (measurement instruments) 72 (only two are shown in FIG. 1) are arranged outside of the exposure light passing region of the optical member 69. The accelerometers 72 measure the relative inclination (relative positional relationship) between the optical member 69 and the projection optical system PL by measuring the acceleration applied to the optical member 69, and the results of measurement are output to the main controller 70, which acts as an adjustment apparatus (see FIG. 6)

Meanwhile, on the outside circumference of the lens barrel of the projection optical system PL, flange 23 which is integral with the lens barrel is provided. The projection optical system PL is inserted from the top relative to the optical axis direction (the Z-axis direction) into the lens barrel support plate 25, which is made of cast material, and is substantially horizontally supported through anti-vibration units 24 to step portion 8b of the reaction frame 8. Here, highly rigid and low thermal expansion ceramic material may be used as the lens barrel support plate 25.

Low thermal expansion material such as Inver (inver; a low thermal expansion alloy made of 36% nickel, 0.25% manganese, iron containing a small amount of carbon and other elements) is used as the material of the flange 23. The flange 23 constitutes a so-called kinematic support mount in which the projection optical system PL is supported at three positions, a point, a surface and a V-groove, against the lens barrel support plate 25. Adoption of such a kinematic support structure makes the installation of the projection optical system PL against the lens barrel support plate 25 easy, and, in addition, provides benefits, such as the effective reduction in vibration of the lens barrel support plate 25 and the projection optical system PL and the stress caused by temperature changes and the like after installation has been accomplished.

An anti-vibration unit 24 is arranged at each corner of the lens barrel support plate 25 (only two of the anti-vibration units 24 are shown in FIG. 1) and has a structure in which an air mount 26 with an adjustable inner pressure and a voice coil motor 27 which applies force for the lens barrel support plate 25 are arranged in series on the step portion 8b. By means of the anti-vibration units 24, minute vibrations transmitted to the lens barrel support plate 25 (and ultimately to the projection optical system PL), the reticle base plate 3 through the support plate 10, and reaction frame 8 are insulated at the micro G level.

On the lens barrel support plate 25, a plurality (three for example, only one is shown in FIG. 1) of accelerometers 73 are provided as detection apparatus for the detection of relative velocity with the wafer base plate 6. The measurement results of the accelerometer 73 are output to the main controller 70, acting as the drive control apparatus of the wafer stage 5 (see FIG. 6). The main controller 70 controls vibration of the projection optical system PL by driving the anti-vibration units 24 based on the output from the accelerometers 73, the details of which are described hereafter.

FIG. 1 shows that stage apparatus 7 is installed on the support plate 10 away from the stage apparatus 4 and the projection optical system PL. The stage apparatus 7 includes a wafer stage 5, an object table ST which suction-supports the wafer W and is integral with the wafer stage 5, and an X guide bar XG which supports the wafer stage 5 and the object table ST in such a manner that they move freely. A plurality of non-contact air bearings (air pads) 28 are attached on the bottom surface of the wafer stage 5. Through the air bearings 28, wafer stage 5 is float supported above the wafer base plate 6 with a clearance of several microns

Wafer base plate 6 is supported substantially horizontally through antivibration units 29 on the upper section of the support plate 10. An anti-vibration unit 29 is arranged at each corner of the wafer base plate 6 (only two anti-vibration units 29 are shown in FIG. 1) and has a structure in which an air mount 30 with an adjustable inner pressure and a voice coil motor 31 (thrust or force providing apparatus) which provides thrust to the wafer base plate 6 are arranged in series on the support plate 10. By means of anti-vibration units 29, minute vibrations transmitted to wafer base plate 6 through support plate 10 are insulated at the micro G level. Here, the relative position of wafer base plate 6 relative to the support plate 10 (i.e., the floor) is detected by a position sensor 78 and output to the main controller 70 (see FIG. 6).

On the wafer base plate 6, a plurality (three for example, only one is shown in FIG. 1) of accelerometers 74 are provided as detection apparatus for detection of the velocity of the wafer base plate 6 relative to the lens barrel support plate 25 (projection optical system PL) and as the vibration detection apparatus for detecting vibration characteristics of the wafer base plate 6. The measurement results of the accelerometers 74 are output to the main controller 70 acting as the drive control apparatus of the wafer stage 5 (see FIG. 6). The main controller 70 controls the vibration relative to the projection optical system PL by driving the anti-vibration units 29 based on the output from the accelerometers 74, the details of which are described hereafter.

FIG. 5 shows that the X guide bar XG has a rectangular shape extending along the X-axis, and movable portions 36, 36 made of armature units are provided on both ends in the length direction of the X guide bar XG. Stationary portions 37, 37 with magnetic units corresponding to the movable portions 36, 36 are provided in the supports 32, 32 which protrude from support plate 10 (see FIG. 1). Moving coil type linear motors 33, 33 are formed by these movable and stationary portions, in such a manner that the X guide bar XG moves in the Y direction by driving the movable portions 36 by a mutual electromagnetic effect with the stationary portions 37, rotating in the θZ direction by adjusting the driving of the linear motors 33, 33. In short, the wafer stage 5 (as well as the object table ST, hereafter simply wafer stage 5) is driven in the Y direction and the θZ direction as one unit with the X guide bar XG by the linear motors 33. The wafer stage 5 is a guideless stage in that it does not have a guide member on base plate 6 for movement in the Y-direction. It also may be made to be a guideless stage, if necessary, for the X direction movement of the wafer stage 5.

Wafer stage 5 is non-contact supported and held by the X guide bar XG to be able to move freely relative to the X guide bar XG in the X direction through magnetic guidance made between a magnet and an actuator which maintain a predetermined gap size between the X guide bar XG. Wafer stage 5 is driven in the X direction by the mutual electromagnetic effect generated by an X linear motor 35 containing a stationary portion 35a provided in the X guide bar XG. The movable portion of the X linear motor, not shown, is attached to wafer stage 5.

Wafer W is anchored by means of vacuum suction and the like on the top surface of wafer stage 5 through a wafer holder 41 (see FIG. 1, omitted in FIG. 5). The position of the wafer stage 5 in the X direction is measured in real time by a laser interferometer 44, which measures positional changes of a movable mirror 43 which is attached on a section of the wafer stage 5, with a predetermined resolution, about 0.5˜1 nm for example, relative to a reference mirror 42 which is attached near the bottom end of the lens barrel of projection optical system PL. Here, the position of wafer stage 5 in the Y direction is measured by an unshown reference mirror, a laser interferometer and a movable mirror 48 (see FIG. 5) which are arranged substantially perpendicular to the aforementioned reference mirror 42, movable mirror 43 and interferometer 44. Moreover, at least one of the laser interferometers are multi-axis interferometers having more than one length measurement axis, and based on the measurement values of the laser interferometers, the XY positions, θ rotation amount and/or the leveling amount of the wafer stage 5 (and ultimately the wafer W) are measured.

A movable portion 34a of an X trim motor (reaction force transmission apparatus) made of a voice coil motor is attached to the -X direction side of the X guide bar XG. X trim motor 34 is installed between X guide bar XG acting as the stationary portion of X linear motor 35 and the reaction frame 8, and a stationary portion 34b of the X trim motor is provided on the reaction frame 8. Hence, the reaction force generated by driving wafer stage 5 in the X direction is transmitted to the reaction frame 8 through the X trim motor 34, and further transmitted to support plate 10 through the reaction frame 8.

Furthermore, three laser interferometers 45 are attached (however, only one laser interferometer is shown in FIG. 1) on three different positions on flange 23 of the projection optical system PL, and functions as detection apparatus for detecting the relative position of the projection optical system PL relative to the wafer base plate 6 in the Z direction. Aperture lens 25a is formed in a section of lens barrel support plate 25 facing each laser interferometer 45, through which aperture 25a, a laser beam (length measurement beam) in the Z direction is irradiated toward the wafer base plate 6 from each laser interferometer 45. A reflection mirror is formed in each location facing the respective length measurement beam on the top surface of the wafer base plate 6. Hence, Z positions of three points on wafer base plate 6 are respectively measured relative to flange 23 (however, in FIG. 1, because a condition in which the shot region in the center of wafer W on wafer stage 5 is directly under the optical axis of projection optical system PL is shown, the length measurement beam is shielded by wafer stage 5). Here, a reflective mirror may be formed on the top surface of wafer stage 5 and an interferometer may be provided to measure three Z direction positions on the reflective mirror relative to the projection optical system PL or flange 23.

Three accelerometers 75, 73, 74 which measure the Z direction vibration for respective plates are installed on the reticle base plate 3, the lens barrel support plate 25 and the wafer base plate 6 as a vibration sensor group. However, in addition, three vibration sensors (an unshown accelerometer, for example) for measuring vibration towards the inner direction of the XY plane may be installed on each plate. Two of these vibration sensors are for measuring the Y direction vibration of each plate, and the remaining vibration sensor is for measuring X direction vibration (hereafter, these vibration sensors are denoted as vibration sensor group 77 for the sake of convenience; see FIG. 6). The main controller 70 is made to obtain (determine) respective vibrations in six degrees of freedom (X, Y, Z, θX, θY, θZ) of the reticle base plate 3, the wafer base plate 6 and the lens barrel support plate 25 based on the measurement values of the accelerometers 73-75 and the vibration sensor group 77.

FIG. 6 shows the control system of the exposure apparatus 1. The drawing shows that the measurement results of each type of measurement instrument such as the position sensor, accelerometer, vibration group, etc. is output to the main controller 70. The main controller 70 executes various algorithms based on the measurement results of the measurement instrument, and collectively controls the reticle driving linear motor, the wafer driving linear motor, the wafer driving trim motor, the movable reticle blind driving actuator, the anti-vibration units and the like based on the results of executing the algorithms. A memory 76 for storing vibration patterns (vibration characteristics) of the reaction frame 8 as a map is provided for the main controller 70.

An exposure process operation of the stage apparatus and exposure apparatus, which are structured in the manner described above, will be explained next.

First, the vibration characteristics of the wafer base plate 6 corresponding to each position of wafer stage 5, and the center of gravity and main inertia axis of the stage apparatus 7 corresponding to each position of wafer stage 5 are obtained prior to exposure processing. In order to obtain the vibration characteristics of the wafer base plate 6, the wafer stage 5 is positioned in the vicinity of the −X side end section, the vicinity of the central section and the vicinity of the +X side end section (right side, center, left side respectively in FIG. 1) on the wafer base plate 6, for example. Then, the wafer stage 5 is moved at that position, and the vibration resulting from the movement is measured by the accelerometer 74 and the vibration sensor group 77. Such vibration data is stored in memory 76.

FIG. 7 illustrates the acceleration output of the rotational component detected at this time. FIG. 7A shows the acceleration output that is detected at the −X side of the wafer base plate 6, FIG. 7B shows the acceleration output detected at the central section of the wafer base plate 6, and FIG. 7C shows the acceleration output detected at the +X side of the wafer base plate 6. The main controller 70 establishes and stores in memory 76 a map of the acceleration output pattern (thrust pattern) which offsets (reduces) the output pattern of the acceleration obtained and the correction coefficients corresponding to the position of the wafer stage 5. Here, the movement pattern of the wafer stage 5 during establishment of the map is the same as the movement pattern used during actual exposure of a substrate.

In order to obtain the position of the center of gravity and the main inertia axis of the stage apparatus 7, the wafer stage 5 is stopped in the aforementioned vicinity of the −X side end section, the vicinity of the central section and the vicinity of the +X side end section respectively, and the main controller 70, for example, drives voice coil motors 31 of the anti-vibration units 29 to provide a dummy vibration with an impulse wave pattern to the wafer base plate 6. Based on the detection results of the vibration caused by the vibration sensor group 77 and the accelerometer 74, the main controller 70 executes a predetermined algorithm sequence, and the position of the center of gravity and the main inertia axis in the inertia system of the stage apparatus 7 corresponding to the position of wafer stage 5 are obtained and identified. Moreover, by the aforementioned identification process, the position of the center of gravity P and the main inertia axis ζ, η, ξ are obtained. Here, the vibration applied to the wafer base plate 6 may be generated by driving the wafer stage 5 rather than driving the voice coil motor. Moreover, the measurement locations of wafer stage 5 may be arbitrary positions rather than the three locations mentioned above.

After obtaining the thrust map, the position of the center of gravity and main inertia axis of the inertia system are obtained, and the exposure process is executed. Here, various exposure conditions for scanning exposure of the shot regions on the wafer W with an optimal exposure amount (target exposure amount) are established beforehand. In addition, preparation work such as reticle alignment and baseline measurement using an unillustrated reticle microscope and off-axis alignment sensor are performed, after which fine alignment (EGA; enhancement global alignment and the like) of the wafer W using an alignment sensor is completed and the array coordinates of the plurality of shot regions on wafer W are obtained.

Upon completion of preparations for exposure of the wafer W in this manner, the wafer stage 5 is moved to the scanning start position for the exposure of the first shot region of wafer W by controlling the linear motors 33, 35, while monitoring the measurement value of the laser interferometer 44 based on the alignment results.

The Y direction scanning of reticle stage 2 and wafer stage 5 is started through the linear motors 33, 35, and when both stages 2, 5 reach the respective target scanning speeds, the predetermined rectangular shaped illumination region on the reticle R is illuminated with uniform illuminance by the exposure illumination light from the illumination optical system IU which is set by the movable reticle blind 62. Synchronously with the Y direction scanning of the reticle R for the illumination region, wafer W for the exposure region, which is conjugate to the illumination region with respect to projection optical system PL, is scanned.

Here by movable reticle blind 62, illumination light is shielded when exposure is not executed, such as during the time prior to exposure by moving the movable blades. The predetermined illumination region is established by forming an aperture when exposure is executed with both stages 2 and 5, namely, reticle R and wafer W reaching their respective exposure positions. As a result, the illumination light irradiated from the light source LS illuminates the reticle R in the rectangular region which is established by the aperture formed by the movable blades.

The illumination light passing through the pattern region in reticle R is reduced in size to ¼ and irradiated onto the wafer W on which a resist is coated. The reticle R pattern is sequentially transferred to the shot region of the wafer W, until the entire pattern region on reticle R has been transferred to the shot region on wafer W in one scanning. During scanning exposure, the reticle stage 2 and wafer stage 5 are synchronously-controlled through linear motors 15 and 33 so that the movement speed in the Y direction of the reticle stage 2 and the movement speed in the Y direction of the wafer stage 5 are maintained with a speed ratio corresponding to the projection reduction (⅕ or ¼) of projection optical system PL.

The reaction force of reticle stage 2 in the scanning direction during acceleration and deceleration is absorbed by the movement of stationary portion 20, and the position of the center of gravity of the stage apparatus 4 is substantially fixed in the Y direction. Even when slight vibration remains in any of the six degrees of freedom directions of the reticle base plate 3 due to reasons such as friction between reticle stage 2, stationary portion 20 and reticle base plate 3, not equaling zero, or the direction of movement of the reticle stage 2 and the stationary portion 20 being slightly different, the air mount 12 and voice coil motor 13 are feedback-controlled in order to eliminate the aforementioned residual vibration based on the measurement values of the vibration sensor group 77 and the accelerometer 75.

Slight vibration is generated in the lens barrel support plate 25 by the movement of the reticle stage 2 and the wafer stage 5. However, main controller 70 obtains vibration amounts in the six degrees of freedom directions based on the measurement values of the vibration sensor group 77 and the accelerometer 73 which are provided for the lens barrel support plate 25, and this slight vibration is cancelled by feedback-controlling air mount 26 and the voice coil motor 27, resulting in the maintenance of the lens barrel support plate 25 at a constantly stabilized position.

Similarly, in stage apparatus 7, the main controller 70, based on the measurement values of laser interferometer 44 and the like, provides a counter force to cancel the effect from the change in the center of gravity caused by the movement of wafer stage 5 on the anti-vibration units 29 in a feed-forward manner, and drives the air mount 30 and the voice coil motor 31 to generate that force. Even when slight vibration remains in the six degrees of freedom directions of wafer base plate 6 due to reasons such as friction between the reticle stage 2, the stationary portion 20 and reticle base plate 3 not equaling zero, the air mount 30 and voice coil motor 31 are feedback-controlled in order to eliminate the aforementioned residual vibration based on the measurement values of the vibration sensor group 77 and the accelerometer 74.

The main controller 70 drives the voice coil motor 31 by transforming to thrust through the position of the center of gravity and the coordinate system of the main inertia axis of the inertia system corresponding to the position of wafer stage 5 which is detected beforehand. In this manner, the appropriate thrust in the coordinate system of the true main inertia axis, rather than a designed value, is applied to wafer base plate 6, resulting in more accurate and effective vibration control.

Furthermore, in driving the voice coil motor 31, the main controller 70 corrects the map of the acceleration output pattern stored in the memory 76 with a correction coefficient corresponding to the position of wafer stage 5 on the wafer base plate 6, and the voice coil motor 31 is driven based on the corrected map.

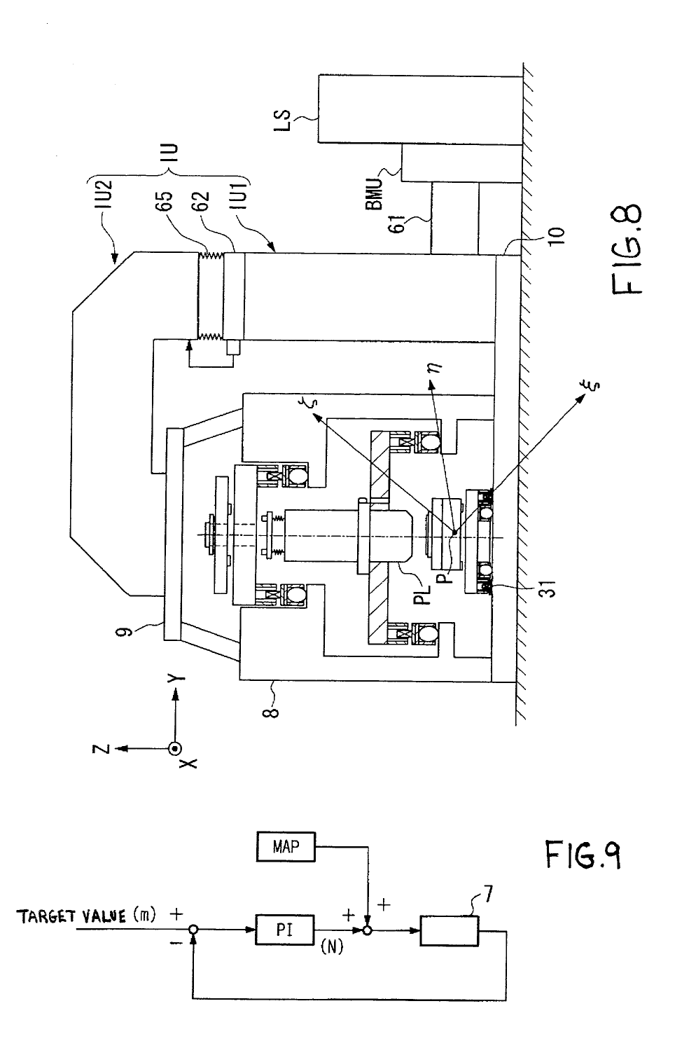

If vibration still remains after driving the voice coil motor 31, the voice coil motor is driven again with an appropriate thrust based on the map by establishing a correction coefficient to reduce the residual vibration. The control loop for this case is shown in FIG. 9. By using a pre-determined map and correction coefficient in this manner, the thrust for the voice coil motor in the stage apparatus 7 is output as a feed-forward thrust command value, and the residual vibration may be effectively reduced in a short period of time.

The acceleration output pattern map is not necessarily created prior to the exposure process, and the invention may be structured in such a manner that the map is created and updated as needed during the exposure process if the map is to be created based on the driving of wafer stage 5 using actual equipment. In fact, if acceleration output is denoted by the two-dot broken line in FIG. 7A, the map may be modified using the output difference ε. Moreover, thrust adjustment using a map is explained for stage apparatus 7 (wafer base plate 6), but for reticle base plate 3 and lens barrel support plate 25 also, voice coil motor thrust may be adjusted depending on the position of the reticle stage 2 and the wafer stage 5, by creating a map beforehand and by using the map and the correction coefficient.

Vibration control and exposure process control associated with stage movement are explained in detail hereafter. Vibration may occur in reaction frame 8 due to the movement of the aforementioned reticle stage 2 and the wafer stage 5. In particular, because the reaction force associated with movement in the X direction of the wafer stage 5 is transmitted to the reaction frame 8 through the X trim motor 34, the second illumination optical system IU2 may vibrate (have relative movement) with respect to the first illumination optical system IU1 through support column 9 due to the residual vibration of the reaction frame 8. Moreover, if the movable reticle blind 62 is driven through the actuator 63 to set the illumination region for the reticle R, the first illumination optical system IU1 may vibrate relative to the second illumination optical system IU2 due to the vibration generated by such driving.

In this case, the main controller 70 moves the movable blades in the X direction and the Y direction respectively through the actuator 63 corresponding to the relative distance between the movable reticle blind 62 and the second illumination optical system IU2 detected by the position sensor 66. As a result, even if vibration such as relative movement of the first illumination optical system IU 1 and the second illumination optical system IU2 occurs, the relative positional relationship between the movable reticle blind 62 and the second illumination optical system IU2, namely the illumination region for reticle R is not changed and is maintained at a predetermined relationship.

An actuator to move the movable reticle blind 62 in the Z direction may be provided so that the relative positional relationship in the Z direction also may be corrected.

Due to slight vibrations of the projection optical system PL, the optical member 69 may tilt relative to the projection optical system PL. In this case, the exposure light passing through the reticle R is incident as parallel beams with tilt relative to the optical axis of projection optical system PL corresponding to the tilt of the optical member 69 caused by the light passing through the optical member 69. As a result, the pattern image of reticle R forms images at a position which is shifted from the predetermined position on the wafer W. Hence, the main controller 70 computes, from the relative tilt between the optical member 69 and the projection optical system PL measured by the accelerometer 72, a shift amount of the pattern being formed on the wafer W, and drives the reticle stage 2 to correct for the shift amount. To be more specific, the driving amount for the reticle stage 2 is made to contain an offset value corresponding to the shift amount. In this manner, the position of the pattern image to be formed on the wafer W is corrected to a predetermined position. Here, a measurement instrument to measure the relative distance, such as a laser interferometer may be used instead of the accelerometer as a means to measure the relative position between the optical member 69 and the projection optical system PL. Moreover, in order to correct the shift amount of the pattern formed on the wafer W, the offset value corresponding to the shift amount may be included in the driving amount of the wafer stage 5 instead of the driving amount of the reticle stage 2.

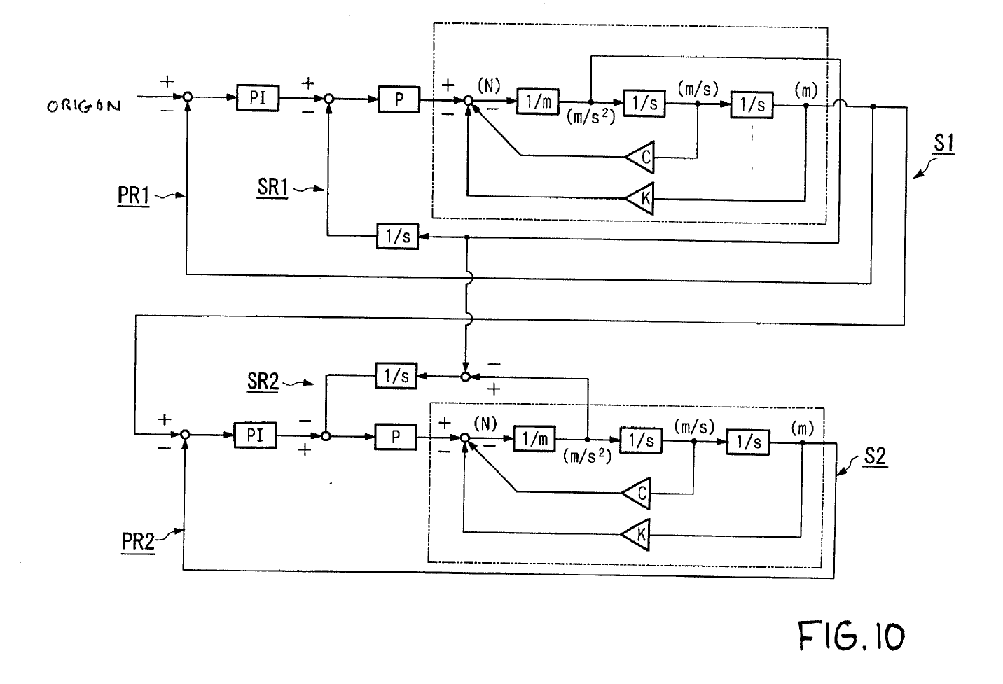

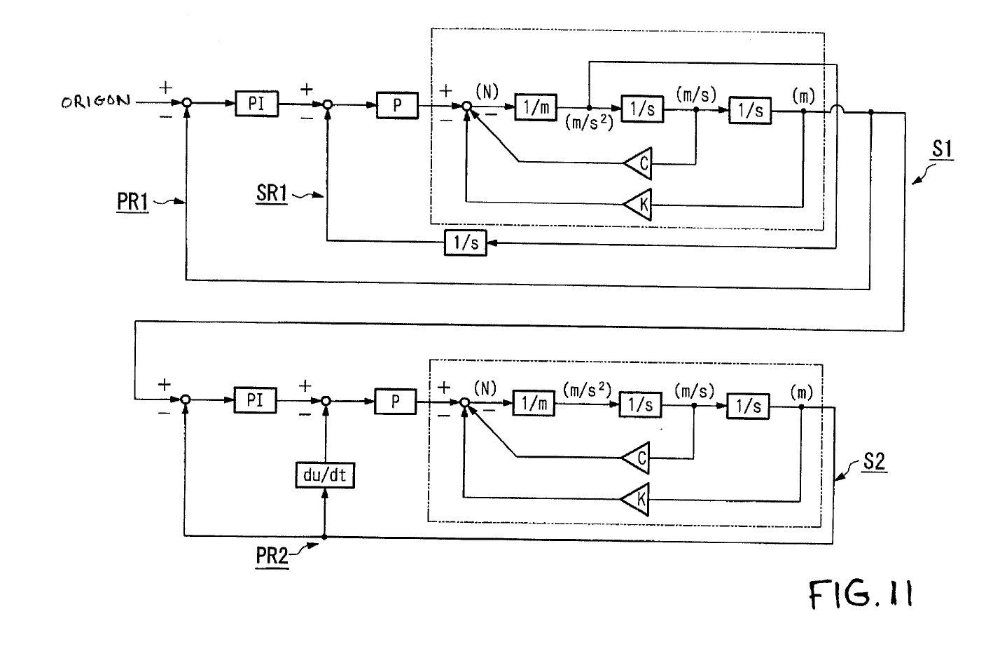

In the aforementioned execution of scanning exposure, the lens barrel support plate 25 and the wafer base plate 6, namely the projection optical system PL and wafer W, are made to be follow-up controlled by the speed control system. The control loop is illustrated in FIG. 10. In FIG. 10, symbol S1 denotes a control loop (control system) for the projection optical system PL (namely lens barrel support plate 25 and anti-vibration units 24), and the symbol S2 is a control loop (control system) for wafer W (namely wafer base plate 6 and the anti-vibration units 29). The two-dot broken line in control system S1 represents the plant unit, including the lens barrel support plate 25 and the anti-vibration units 24, while two-dot broken line in the control system S2 represents the plant unit including the wafer base plate 6 and the anti-vibration units 29.

As shown in FIG. 10, the control system S1 includes a cascade type control system in which the velocity control loop SR1 forming a speed servo by the speed obtained by integrating acceleration detected by the accelerometer 73 is a minor loop and position control loop PR1, which controls the velocity control loop SR1 based on the measurement results of position sensor 78, is a main loop. Similarly, the control system S2 includes a cascade type control system in which velocity control loop SR2 forming a speed servo by the speed obtained by integrating acceleration detected by the accelerometer 74 is a minor loop, and position control loop PR2, which controls velocity control loop SR2 based on the measurement results of a laser interferometer 45, is a main loop. Here, in the speed control loop, vibration in the 10˜20 Hz high frequency range is mainly controlled, whereas in the position control loop, the vibration in the low frequency range such as 0.1 Hz is controlled.

In the present embodiment, the acceleration in velocity control loop SR1 of control system S1 is output to velocity control loop SR2. In control system S2, velocity servo is executed with the relative velocity obtained by integrating the difference between the acceleration of wafer base plate 6 and the acceleration of lens barrel support plate 25, namely relative acceleration. As a result, the wafer base plate 6 is made to follow and to be driven under velocity control relative to the lens barrel support plate 25. In other words, wafer W is synchronously-driven to follow the projection optical system PL.

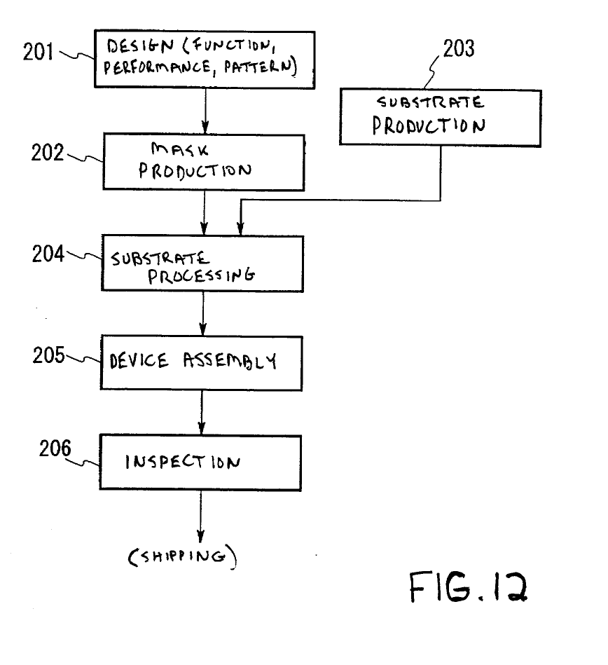

Here, the relative velocity of projection optical system PL and the wafer W may be detected by differentiating the detection results of the laser interferometer 45, which detects the relative distance between projection optical system PL and the wafer base plate 6 without using accelerometers 73, 74. As shown in FIG. 11, a control loop for this case. FIG. 11 describes that, in the control system S2, velocity may be controlled by the relative velocity obtained by differentiating relative distance detected by the laser interferometer 45.

As explained above, in the stage apparatus and the exposure apparatus of the present embodiment, by executing velocity control with relative velocities detected from the acceleration applied to the lens barrel support plate 25 and the acceleration applied to the wafer base plate 6, namely acceleration applied to projection optical system PL and acceleration applied to wafer W, wafer W is made to follow the projection optical system PL in the optical axis direction, enabling synchronization of the projection optical system PL and the wafer W in the optical axis direction, even if the projection optical system PL vibrates for some reason, resulting in maintenance of the relative positional relationship of projection optical system PL and the wafer W. For this reason, even when patterns on the reticle R are exposed and formed on wafer W, the focal position of projection optical system PL is always maintained at the predetermined position (i.e., at the resist coated surface) of wafer W, preventing the occurrence of a blurred image and the like and improving exposure accuracy. Here, a similar effect is achieved when the relative velocity is computed by differentiating the relative distance between the projection optical system PL and the wafer base plate 6 obtained from measurement results of the laser interferometer 45.

Moreover, in the stage apparatus and the vibration control method of the present embodiment, the position of the center of gravity and the major inertia axis when vibration occurs in the wafer base plate 6 are obtained and the thrust to be applied to the surface plate is corrected based on the position of the center of gravity and the major inertia axis, and appropriate thrust corresponding to the true inertia system can be applied, resulting in accurate and effective vibration control (reduction of high frequency vibration). While accurate vibration control similar to the aforementioned case may be executed by controlling vibration after obtaining the position of the center of gravity and the major inertia axis of the apparatus through simulation, it is preferable that the position of the center of gravity and the major inertia axis are obtained not from a design value but by applying vibration to the wafer base plate 6 using the actual equipment, resulting in more accurate vibration control.

In the present embodiment, the position of the center of gravity and the major inertia axis are respectively detected corresponding to the various possible positions of the wafer stage 5 relative to the wafer base plate 6. Hence, every time the wafer stage 5 is moved due to a scanning or step operation, the thrust to be applied to the wafer base plate 6 may be obtained through transformation to the accurate position of the center of gravity and the coordinate system based on the major inertia axis. Moreover, the direction towards the position of the center of gravity instead of the direction along the Z axis may be used as a direction of applying thrust to the wafer base plate 6. In this case, rotational moment is not generated when thrust is applied, hence more stable and high frequency vibration control becomes possible.

Furthermore, in the present embodiment, vibration characteristics of the reaction frame 8 are stored as a map beforehand, and using the map and the correction coefficient corresponding to the position of wafer stage 5, the thrust of the voice coil motor in the stage apparatus 7 is output as a thrust command value in a feed-forward manner. Hence, residual vibration is effectively reduced and the time needed for settling is shortened. This map may be obtained by driving wafer stage 5 using actual equipment, and consideration of correction terms is not necessarily contrary to a case in which the map is obtained by computation or experiment, resulting in the storage of more accurate vibration characteristics conforming to the actual equipment.

In the present embodiment, the movable reticle blind 62 is arranged to vibrate independent of the reaction frame 8. Hence, the transmission of vibration, caused by driving the blades, to the projection optical system PL and to the reticle R through the reaction frame 8 is prevented, resulting in improved exposure accuracy by effectively preventing the occurrence of a shift in the pattern transferring position, and image blurring and the like due to the vibration. Moreover, illumination unit IU1 may remove relative to illumination unit IU2 due to vibration associated with driving of reticle stage 2 and wafer stage 5 or driving of movable reticle blind 62, but in the present embodiment, the movable blades are moved relative to the X direction and the Y direction respectively, depending upon the relative distance of the movable reticle blind 62 and the second illumination optical system IU2, and the illumination region is maintained at a predetermined position relative to the reticle R, and the reduction of pattern positioning accuracy and overlaying accuracy to be exposed and formed on wafer W may be prevented beforehand. Moreover, the present embodiment is able to handle the two-dimensional relative movement of the first illumination optical system IU1 and the second illumination optical system IU2, because the positions of the movable blades are adjusted in a two-dimensional plane.

In the present embodiment, the shift amount of the pattern to be imaged on wafer W is computed from the optical member 69 and the projection optical system PL, and the driving amount of the reticle stage 2 is corrected to correct the shift amount. Therefore, the shift in the pattern position on wafer W caused by the position error of the optical member 69 is prevented, which contributes to an improvement in exposure accuracy.

Here, the embodiment is structured in such a manner that the voice coil motor is used as the X trim motor 34 for transmitting the reaction force applied to the X guide bar XG generated by the movement of the wafer stage 5 to the reaction frame 8, but other structures, such as a structure in which an EI core actuator, which is a combination of an E-type core and an I-type core, is installed may be used as well. In this case, either an E-type core or an I-type core is arranged on the X guide bar XG side and the other (i.e., the I-type core or the E-type core) is arranged on reaction frame 8 side and either a moving coil type or a moving magnet type may be used. If a moving magnet type is used, wiring for moving the X guide bar becomes unnecessary, resulting in the simplification of the apparatus structure and the elimination of adverse effects from the vibration being transmitted through wiring. If a moving coil type is used, the area of the coil, through which electric current runs, may be minimized, enabling control of the effect of heat generated by the running current.

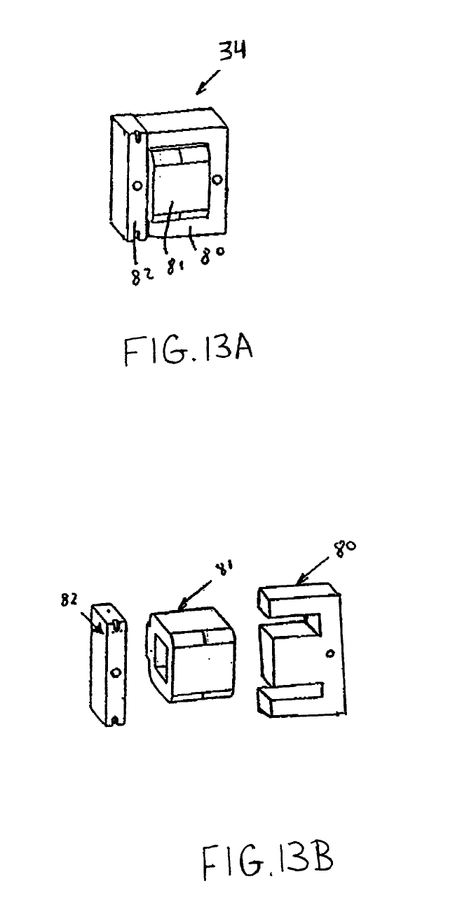

One example of a known, EI core actuator is shown in FIGS. 13A and 13B. The EI core actuator is essentially an electromagnetic attractive device. Each EI core actuator includes an E-shaped core 80, a tubular connector 81, and an I-shaped core 82. The E-shaped core 80 and the I-shaped core 82 are each made of a magnetic material such as iron, silicon steel, or Ni—Fe steel, for example. The conductor 81 is positioned around the center bar of the E-shaped core 80. A very small air gap is provided between the I-shaped core 82 and the combination of the E-shaped core 80 and the conductor 81. For more details on EI core actuators, see U.S. patent application Ser. No. 09/714,747, the disclosure if which is incorporated herein by reference in its entirety.

The EI core actuator is able to output 1.5 times as much thrust as a voice coil motor. Hence, installation of an EI core actuator as the X trim motor 34 reduces the size of the voice coil motor to output the same amount of thrust by about ⅓, enabling miniaturization of the apparatus. In particular, the reaction force applied to the X guide bar XG can be as large as 1,000 N; hence the difference in the size of motors that output thrust strong enough to transmit the reaction force contributes greatly to miniaturization of the overall size of the apparatus.

The X trim motor 34 adjusts the position P of the X guide bar XG in the X direction. Hence, the relative position of the E-type core and the I-type core in the EI core actuator needs to be strictly controlled. In order for the EI core actuator to output sufficient thrust, the relative position between the E-type core and the I-type core needs to be regulated within a predetermined region. Hence a measuring instrument is preferably provided to measure the relative positional relationship. In this case, the main controller 70 is able to maintain the relative position within a predetermined range by controlling the bias current based on the measured relative position between the E-type core and the I-type core, resulting in the constant output of thrust strong enough to counter the reaction force applied to the X guide bar XG.

In the aforementioned embodiment, the stage apparatus of the invention is applied to an exposure apparatus 1, but in addition, the stage apparatus may be applied to precision measurement equipment, such as a mask etching apparatus and mask pattern position coordinate measuring apparatus. Moreover, in the embodiment, linear motors 15, 33 are of a moving coil type, but they also can be of a moving magnet type.

In addition to semiconductor wafer W for a semiconductor device, the present invention may be applied to a glass substrate for forming a liquid crystal display, a ceramic wafer for forming thin film magnetic heads, and original plates for forming a mask or a reticle (synthetic silica, silicon wafer) used in the exposure device as a substrate in the embodiment.

In addition to a scanning type exposure apparatus (scanning stepper; see U.S. Pat. No. 5,473,410) which uses the step and scan method to scan and expose patterns on a reticle R by synchronously moving the reticle R and a wafer W, the present invention may be applied to an exposure apparatus (stepper) which uses the step and repeat method to expose the pattern on a reticle R onto a wafer W while the reticle and the wafer are stationary.

The present invention may be applied, in addition to exposure apparatus for a semiconductor device production that exposes a semiconductor device pattern onto wafer W, to many types of exposure apparatus such as exposure apparatus for liquid crystal display device production and exposure apparatus for producing a thin film magnetic head, an image pick-up element (CCD) and a reticle.

Moreover, as the light source of the exposure illumination light, charged particle beams such as X rays and electron beams may be used in addition to the luminescent line (g-line (436 nm), h-line (404.7 nm), i-line (365 nm)) generated by a super high pressure mercury lamp, KrF excimer laser (248 nm), ArF excimer laser (193 nm) and F2 laser (157 nm). For example, if an electron beam is used, a hot electron irradiation type hexthabolite lanthanum (LaB6) and tantalum (Ta) may be used as an electron gun. Moreover, if an electron beam is used, a reticle R may be used or, instead of using reticle R, a pattern may be formed directly on the wafer. Moreover, high frequency waves such as YAG lasers and semiconductor lasers may be used.

Magnification of the projection optical system PL may be a ratio of one (unity magnification) or an enlargement as well as a reduction. Moreover, for the material of the projection optical system PL, silica and fluorite which transmit far ultraviolet rays may be used as the glass material when far ultraviolet rays, such as produced by an excimer laser, is used. In addition, a reflective refractive or a purely reflective optical system may be used if the F2 laser or X ray is used (reflective type reticle is used for the reticle R also), and an electron optical system made of an electron lens and deflecting system may be used as an optical system if an electron beam is used. Moreover, the present invention is applicable to a proximity exposure apparatus which expose a pattern on a reticle R by a placing reticle R and wafer W close to each other without using a projection optical system PL between them.

If a linear motor is used for the wafer stage 5 and the reticle stage 2 (see, e.g., U.S. Pat. No. 5,623,853 or U.S. Pat. No. 5,528,118) an air float type using air bearings or a magnetic float type using Lorentz force may be used. Moreover, each stage 2 and 5 may be a type in which a guide is provided for movement, or they may be a guideless type without guides.

For the driving mechanism of each stage 2 and 5, use may be made of a planar motor that drives each stage 2, 5 with the electromagnetic force generated by placing a magnet unit (permanent magnet) in which magnets are arranged in a plane and an armature unit in which a coil is arranged in a plane in such a manner that they face each other. In this case, it is sufficient to connect either the magnet unit or the armature unit to stages 2 and 5 and the other to the moving surface side (base) of the stages 2 and 5.

As explained above, the exposure apparatus 1 of the present embodiment is created by assembling various subsystems containing each of the structural elements described herein in such a manner that predetermined mechanical, electrical and optical accuracy are maintained. In order to maintain these various accuracies, adjustments to achieve optical accuracy for various optical systems, adjustment to achieve mechanical accuracy for various mechanical systems and adjustment to achieve electrical accuracy for various electrical systems are performed before and after the assembly process. The assembly process from each subsystem to the exposure apparatus includes mechanical connection, wiring connection to electric circuits, piping connection to air pressure circuits and the like between each subsystem.

The assembly process of each individual subsystem is completed before the assembly process of the various subsystem to form the exposure apparatus. Upon completion of assembling the exposure apparatus from the various subsystems, overall adjustment is performed to assure various accuracies as an entire exposure apparatus. Here, the production of an exposure apparatus is preferably conducted in a clean room where production temperature and cleanliness are controlled.

As shown in FIG. 12, a semiconductor device is produced starting with step 201 in which the function and performance of the device are designed. Then, in step 202, the mask (reticle) is manufactured based on the results of the design step. In step 203, the wafer is created from silicon material. Step 204 is a wafer processing step in which reticle patterns are exposed onto the wafer using exposure apparatus 1 of the aforementioned embodiment. Then, a device assembly step 205 (including a dicing step, a bonding step and a packaging step), and an inspection step 206 and the like are performed.

While the invention has been described with reference to preferred embodiments thereof, it is to be understood that the invention is not limited to the preferred embodiments or constructions. To the contrary, the invention is intended to cover various modifications and arrangements. In addition, while the various elements of the preferred embodiments are shown in various combinations and configurations, which are exemplary, other combinations and configurations, including more, less or only a single element, are also within the spirit and scope of the invention.

What is claimed is:

1. A vibration control method of a stage apparatus having a main stage body that is driven over a base plate, which controls vibration by applying a force to the base plate, wherein a position of a center of gravity and of a major inertia axis of the stage apparatus, is detected when vibration is applied to the base plate, and the force is adjusted based on the detected position of the center of gravity and the detected position of the major inertia axis.

2. A vibration control method according to claim 1, wherein the vibration is applied to the base plate by driving the main stage body.

3. A vibration control method according to claim 1, wherein the position of the center of gravity and the position of the major inertia axis are detected for different positions of the main stage body relative to the base plate.

4. A stage apparatus having a main stage body that driven over a base plate and a force actuator that applies a force to the base plate, comprising:
a detector that detects a position of a center of gravity and of a major inertia axis of the stage apparatus when vibration is applied to the base plate; and
a controller that controls the force applied to the base plate by the force actuator based on the position of the center of gravity and the position of the major inertia axis detected by the detector.

5. A stage apparatus according to claim 4, wherein the force actuator applied the force towards the detected position of the center of gravity.

6. An exposure apparatus that exposes a pattern of a mask held by a mask stage onto a substrate held by a substrate stage, wherein at least one of the mask stage and the substrate stage is the stage apparatus according to claim 4.

7. An exposure apparatus according to claim 6, wherein the exposure apparatus is a scanning exposure apparatus that exposes the pattern of the mask onto the substrate while synchronously scanning the mask and the substrate.

8. A stage apparatus having a main stage body that is driven over a base plate, comprising:
a drive apparatus having a stationary portion and a movable portion that drive the main stage body;
a support arranged to vibrate independently from the base plate; and
a reaction force transmission apparatus, provided between the support and the stationary portion, and that transmits a reaction force generated in the stationary portion by the movement of the main stage body to the support, wherein the reaction force transmission apparatus comprises an EI core actuator made by connecting an E-type core and an I-type core.

9. A stage apparatus according to claim 8, further comprising a measuring instrument that measures a relative position between the E-type core and the I-type core, and a controller that controls driving of the EI core actuator based on the measurements made by the measuring instrument.

10. An exposure apparatus that exposes a pattern of a mask held by a mask stage onto a substrate held by a substrate stage, wherein at least one of the mask stage and the substrate stage is the stage apparatus according to claim 8.

11. An exposure apparatus according to claim 10, wherein the exposure apparatus is a scanning exposure apparatus that exposes the pattern of the mask onto the substrate while synchronously scanning the mask and the substrate.

12. A stage apparatus having a main stage body that is driven over a base plate and a force actuator that applies a force to the base plate, comprising;
a memory that stores vibration characteristics of the base plate corresponding to different positions of the main stage body;
a vibration detector that detects the vibration characteristics of the base plate; and
a controller that controls the force actuator based on the vibration characteristics detected by the vibration detector and stored in the memory.

13. A stage apparatus according to claim 12, wherein the memory stores the vibration characteristics of the base plate when the main stage body is driven.

14. An exposure apparatus that exposes a pattern of a mask held by a mask stage onto a substrate held by a substrate stage, wherein at least one of the mask stage and the substrate stage is the stage apparatus according to claim 12.

15. An exposure apparatus according to claim 14, wherein the exposure apparatus is a scanning exposure apparatus that exposes the pattern of the mask onto the substrate while synchronously scanning the mask and the substrate.

16. An exposure apparatus that transfers a pattern of a mask onto a substrate by a projection optical system, comprising:
a detector that detects a relative velocity between the projection optical system and the substrate in an optical axis direction of the projection optical system; and
a drive controller that causes at least the substrate the follow the projection optical system in the optical axis direction based on the relative velocity detected by the detector.

17. An exposure apparatus according to claim 16, wherein the detector detects the relative velocity by determining an acceleration applied to the projection optical system and an acceleration applied to the substrate.

18. An exposure apparatus according to claim 16, wherein the detector detects the relative velocity by determining the relative position of the projection optical system and the substrate in the optical axis direction.

19. An exposure apparatus according to claim 16, further comprising:
a stage that moves while holding the substrate; and
a base plate that movably supports the stage;
wherein the detector detects the relative velocity through the base plate.

20. An exposure apparatus according to claim 16, wherein the exposure apparatus is a scanning exposure apparatus that exposes the pattern of the mask onto the substrate while synchronously scanning the mask and the substrate.

21. An exposure apparatus that includes an illumination optical system that illuminates a mask in order to transfer a pattern of the mask onto a substrate, comprising:
a support that supports at least one portion of the illumination optical system and the mask;
an illumination region defining unit that sets an illumination region of the mask, arranged so that the illumination region defining unit vibrates independently of the support;
a detector that detects a relative positional relationship between the at least one portion of the illumination optical system and the illumination region defining unit; and
a controller that controls adjustment of a position of the illumination region defining unit based on the relative positional relationship detected by the detector.

22. An exposure apparatus according to claim 21, wherein the illumination region defining unit changes a size of the illumination region of the mask depending upon whether or not exposure is executed.

23. An exposure apparatus according to claim 21, wherein the controller causes adjustment of the position of the illumination region defining unit within a two-dimensional plane.

24. An exposure apparatus according to claim 21, wherein the exposure apparatus is a scanning exposure apparatus that exposes the pattern of the mask onto the substrate while synchronously scanning the mask and the substrate.

25. An exposure method in which an illumination optical system illuminates a mask in order to transfer a pattern of the mask onto a substrate, comprising:
supporting at least one portion of the illumination optical system and the mask on a common support;
arranging an illumination region defining unit that sets an illumination region of the mask, so that the illumination region defining unit vibrates independently of the common support;
detecting a relative positional relationship between the at least one portion of the illumination optical system and the illumination region defining unit; and
adjusting a position of the illumination region defining unit based on the detected relative positional relationship.

26. A method according to claim 25, wherein the illumination region defining unit changes a size of the illumination region of the mask depending upon whether or not exposure is executed.

27. A method according to claim 25, wherein the position of the illumination region defining unit is adjusted within a two-dimensional plane.

28. An exposure apparatus that transfers a pattern of a mask onto a substrate through a projection optical system located between the mask and the substrate, comprising:
an optical member arranged between the mask and the projection optical system;
a measurement instrument that measures a relative positional relationship between the optical member and the projection optical system; and
a controller that controls adjustment of a position of the image of the pattern of the mask that is projected onto the substrate based on the relative positional relationship measured by the measurement instrument.

29. An exposure apparatus according to claim 28, further comprising a mask stage that moves while holding the mask, and wherein the controller causes the mask stage to be driven based on the relative positional relationship measured by the measurement instrument.

30. An exposure apparatus according to claim 28, wherein the optical member is supported by the projection optical system.

31. An exposure apparatus according to claim 28, wherein the optical member transmits parallel light beams into the projection optical system.

32. An exposure apparatus according to claim 28, wherein the exposure apparatus is a scanning exposure apparatus that exposes the pattern of the mask onto the substrate while synchronously scanning the mask and the substrate.

33. A method of transferring a pattern of a mask onto a substrate through a projection optical system located between the mask and the substrate, comprising:
arranging an optical member between the mask and the projection optical system;
measuring a relative positional relationship between the optical member and the projection optical system; and
adjusting a position of the image of the pattern of the mask that is projected onto the substrate based on the measured relative positional relationship.

34. A method according to claim 33, wherein the adjusting step includes causing a mask stage that moves while holding the mask to be driven based on the measured relative positional relationship.

35. A method according to claim 33, wherein the optical member is supported by the projection optical system.

36. A method according to claim 33, wherein the optical member transmits parallel light beams into the projection optical system.
